(19) United States
(12) Patent Application Publication
(10) Pub. No.: US 2006/0120226 A1
(43) Pub. Date: Jun. 8, 2006

(54) Optical pick-up device and optical disk device

(75) Inventors: Junichi Mutou, Munakata-shi (JP); Hiroshi Sato, Kumamoto-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/273,020

(22) Filed: Nov. 15, 2005

(30) Foreign Application Priority Data
Nov. 16, 2004 (JP) 2004-331530
Jan. 5, 2005 (JP) 2005-000389

(51) Int. Cl. G11B 7/00

(52) U.S. Cl. 369/44.11

(57) ABSTRACT

An optical pick-up device for carrying out at least one of recording and reproduction of information for an optical disk, comprises a laser beam source emitting a laser beam; a laser beam source adjusting member disposed on an opposite side of an emitting portion for emitting the laser beam of the laser beam source and having a first sliding surface setting a light emitting point of the laser beam source to be a center of rotation; and a laser module including a laser beam source shift member having a receiving surface for supporting the first sliding surface of the laser beam source adjusting member and having a second sliding surface which is almost perpendicular to an optical axis.

### BACKGROUND OF THE INVENTION

1. Field of the Invention

The present invention relates to an optical pick-up device comprising a mechanism for regulating a light source to be used for recording and reproducing an optical disk, and an optical disk device using the optical pick-up device.

2. Description of the Related Art

Conventionally, various optical disks such as a DVD (digital versatile disk), a CD-R (writable compact disk) and a CD-RW (rewritable compact disk) have been developed as optical recording media. The DVD serves to record or reproduce information through a laser beam having a wavelength of approximately 660 nm. On the other hand, the CD-R and the CD-RW serve to record or reproduce information through a laser beam having a wavelength of approximately 780 nm. There has been proposed an optical disk device mounting an optical pick-up device capable of recording or reproducing information for plural kinds of optical disks.

In such an optical pick-up device, if a laser beam is not emitted from a laser beam source in a proper direction, an intensity of the beam to be irradiated on the optical disk is reduced. For this reason, information can be neither recorded nor reproduced accurately. Therefore, the posture of the laser beam source is regulated in order to emit the laser beam in the proper direction. Such a posture regulation is referred to as an adjustment.

FIG. 21 is a view showing a schematic structure of an optical system in a conventional optical pick-up device. For simplicity, one laser beam source is provided, and an optical component for separating an optical path and an optical system for monitoring a light quantity are omitted. A laser beam source 101 is fastened to an adjusting holder 103 provided on an optical disk 108 side. The adjusting holder 103 is supported on a receiving surface 104a of a holder receiver 104 through a sliding surface 103a. The holder receiver 104 is fastened to an optical pick-up device body (not shown). A light emitting point 102 is used for a laser beam seen from a laser beam emitting port. The sliding surface 103a and the receiving surface 104a are spherical planes setting the light emitting point 102 to be a center. By rotating the adjusting holder 103 around the light emitting point 102, accordingly, it is possible to vary a direction of an emission of the laser beam without changing a position of the light emitting point 102. The laser beam source 101 comprising the adjusting mechanism such as the adjusting holder 103 or the holder receiver 104 is referred to as a laser module. A laser beam set to have an optimum emitting direction and emitted from the light emitting point 102 passes through holes provided on the adjusting holder 103 and the holder receiver 104 and are converted into almost parallel lights by means of a collimate lens 105, and a direction thereof is changed into an almost perpendicular direction to the optical disk 108 by means of a rising mirror 106, and the lights are collected into the optical disk 108 by means of an objective lens 107 (see JP-A-2000-276755 Publication)

With a reduction in a size of an optical pick-up device, a position of a laser beam source and an adjusting mechanism are restricted and a sufficient position regulation and an adjustment are also required to be freely carried out for a small space. In particular, a space around an optical disk side of the laser beam source is small. With a conventional structure, however, an adjusting holder and a holder receiver are provided on the optical disk side of the laser beam source. For this reason, the space around the laser beam source cannot be reduced so that it is hard to decrease the size of the optical pick-up device.

### SUMMARY OF THE INVENTION

The invention has been made in order to solve the problems and has an object to provide an optical pick-up device and an optical disk device which can carry out a position regulation and an adjustment of a laser beam source, and furthermore, can reduce a space on an optical disk side of a laser beam source, thereby decreasing sizes.

In order to solve the problems, the invention provides an optical pick-up device for carrying out at least one of recording and reproduction of information for an optical disk, comprising a laser module including a laser beam source having a laser unit for emitting a laser beam, a laser beam source adjusting member disposed on an opposite side of an emitting portion for emitting the laser beam of the laser beam source and having a first sliding surface setting a light emitting point of the laser beam source to be a center of rotation, and a laser beam source shift member having a receiving surface for supporting the first sliding surface of the laser beam source adjusting member and a second sliding surface which is almost perpendicular to an optical axis.

According to the invention, all mechanisms for regulating the laser beam source are provided on an opposite side to the optical disk side of the laser beam source. Therefore, it is possible to reduce a space on the optical disk side of the laser beam source in the optical pick-up device.

The optical pick-up device according to the invention can carry out a position regulation and an adjustment of the laser beam source, and furthermore, can reduce a space on the optical disk side of the laser beam source, thereby decreasing a size more greatly. Therefore, it is possible to implement an optical pick-up device which is smaller-sized and can carry out more stable recording and reproduction.

### BRIEF DESCRIPTION OF THE DRAWINGS

FIG. 1 is a view showing a structure of an optical system of an optical pick-up device according to a first embodiment,

FIG. 2(a) is an exploded view showing a laser module according to the first embodiment and FIG. 2(b) is a view showing a structure of the laser module according to the first embodiment,

FIG. 3 is a view showing an example of the optical pick-up device mounting components illustrated in FIGS. 1 and 2,

FIG. 4 is a view showing a state of an emission of a laser beam and a light intensity distribution in a collimate lens in the case in which a direction of the emission of the laser beam is not inclined to an optical axis,

FIG. 5 is a view showing the state of the emission of the laser beam and the light intensity distribution in the collimate lens in the case in which the direction of the emission of the laser beam is inclined to the optical axis,

FIG. 6 is a perspective view showing an optical disk device according to a second embodiment,

FIG. 7(a) is a top view showing an adjusting member according to the first embodiment and FIG. 7(b) is a perspective view,

FIG. 8(a) is a top view showing a laser beam source shift member according to the first embodiment and FIG. 8(b) is a perspective view,

FIG. 9(a) is a perspective view showing a shape of a cap for a semiconductor laser according to a third embodiment, FIG. 9(b) is a typical top view showing the cap for a semiconductor laser according to the third embodiment as seen in a direction of an arrow A in FIG. 9(a), FIG. 9(c) is a typical top view showing the cap for a semiconductor laser according to the third embodiment as seen in the direction of the arrow A in FIG. 9(a), FIG. 9(d) is a typical top view showing the cap for a semiconductor laser according to the third embodiment as seen in the direction of the arrow A in FIG. 9(a), FIG. 9(e) is a typical top view showing the cap for a semiconductor laser according to the third embodiment as seen in the direction of the arrow A in FIG. 9(a), FIG. 9(f) is a typical top view showing the cap for a semiconductor laser according to the third embodiment as seen in the direction of the arrow A in FIG. 9(a), FIG. 9(g) is a typical top view showing the cap for a semiconductor laser according to the third embodiment as seen in the direction of the arrow A in FIG. 9(a), FIG. 9(h) is a typical top view showing the cap for a semiconductor laser according to the third embodiment as seen in the direction of the arrow A in FIG. 9(a), and FIG. 9(i) is a typical top view showing the cap for a semiconductor laser according to the third embodiment as seen in the direction of the arrow A in FIG. 9(a),

FIG. 10(a) is a perspective view showing the shape of the cap for a semiconductor laser according to the third embodiment, FIG. 10(b) is a typical front view showing the cap for a semiconductor laser according to the third embodiment as seen in a direction of an arrow B in FIG. 10(a), FIG. 10(c) is a typical front view showing the cap for a semiconductor laser according to the third embodiment as seen in the direction of the arrow B in FIG. 10(a), FIG. 10(d) is a typical front view showing the cap for a semiconductor laser according to the third embodiment as seen in the direction of the arrow B in FIG. 10(a), and FIG. 10(e) is a typical front view showing the cap for a semiconductor laser according to the third embodiment as seen in the direction of the arrow B in FIG. 10(a),

FIG. 11(a) is a perspective view showing the shape of the cap for a semiconductor laser according to the third embodiment, FIG. 11(b) is typical top and front views showing the cap for a semiconductor laser according to the third embodiment as seen in directions of arrows A and B in FIG. 11(a), FIG. 11(c) is typical top and front views showing the cap for a semiconductor laser according to the third embodiment as seen in the directions of the arrows A and B in FIG. 11(a), and FIG. 11(d) is typical top and front views showing the cap for a semiconductor laser according to the third embodiment as seen in the directions of the arrows A and B in FIG. 11(a),

FIG. 12(a) is a top view showing a semiconductor laser device using the cap for a semiconductor laser according to the third embodiment in a fourth embodiment and FIG. 12(b) is a front view,

FIG. 13 is a view showing a difference in an attachment state depending on the presence of a slit in the case in which an attachment is carried out by using an adhesive according to a seventh embodiment,

FIG. 14(a) is a top view showing a semiconductor laser device according to a second embodiment and FIG. 14(b) is a front view,

FIG. 15 is an exploded view showing a semiconductor laser device according to a ninth embodiment,

FIG. 16 is a view showing a structure of the semiconductor laser device according to the ninth embodiment,

FIG. 17 is a view showing a structure of an optical system of an optical pick-up device according to a tenth embodiment,

FIG. 18 is a view showing an appearance of the optical pickup device according to the tenth embodiment using an optical system in FIG. 16,

FIG. 19 is a perspective view showing an optical disk device according to an eleventh embodiment,

FIG. 20(a) is a top view showing a semiconductor laser device as a reference example and FIG. 20(b) is a sectional side view showing a semiconductor laser device as a reference example, and

FIG. 21 is a view showing a schematic structure of an optical system of a conventional optical pick-up device.

### DESCRIPTION OF THE PREFERRED EMBODIMENTS

Embodiments of the invention will be described below with reference to the drawings

### First Embodiment

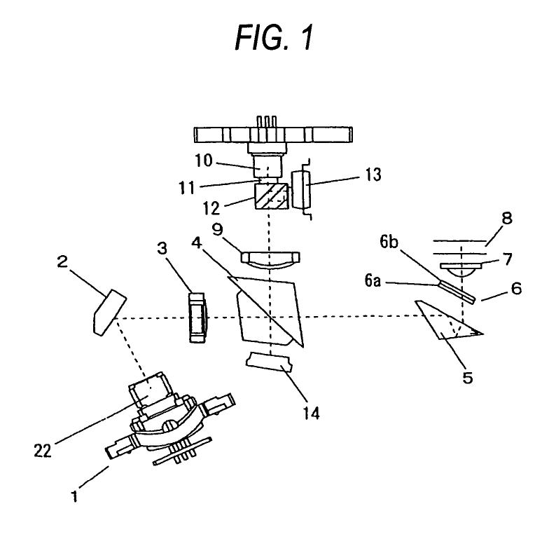

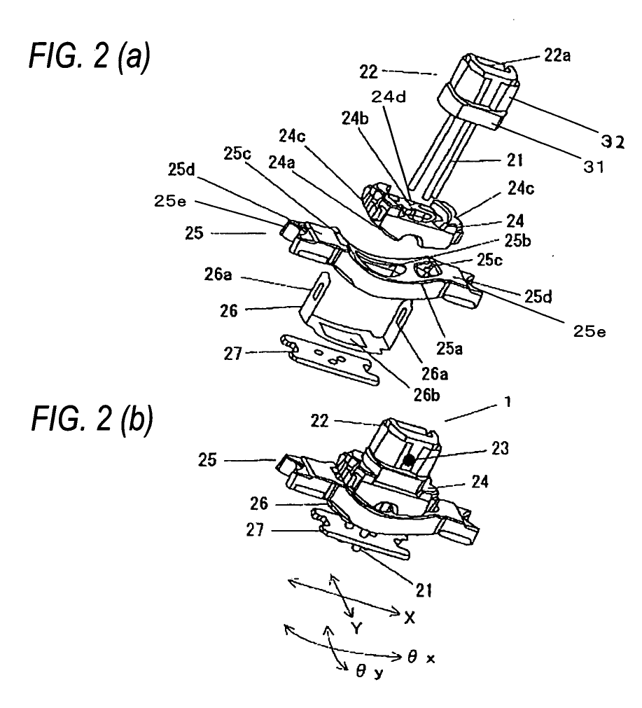

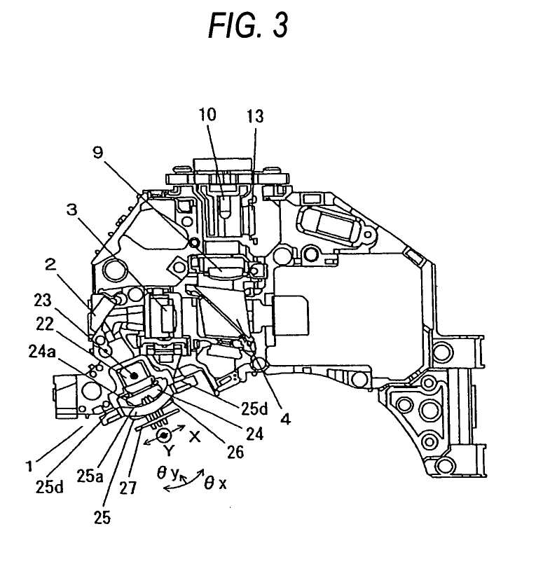

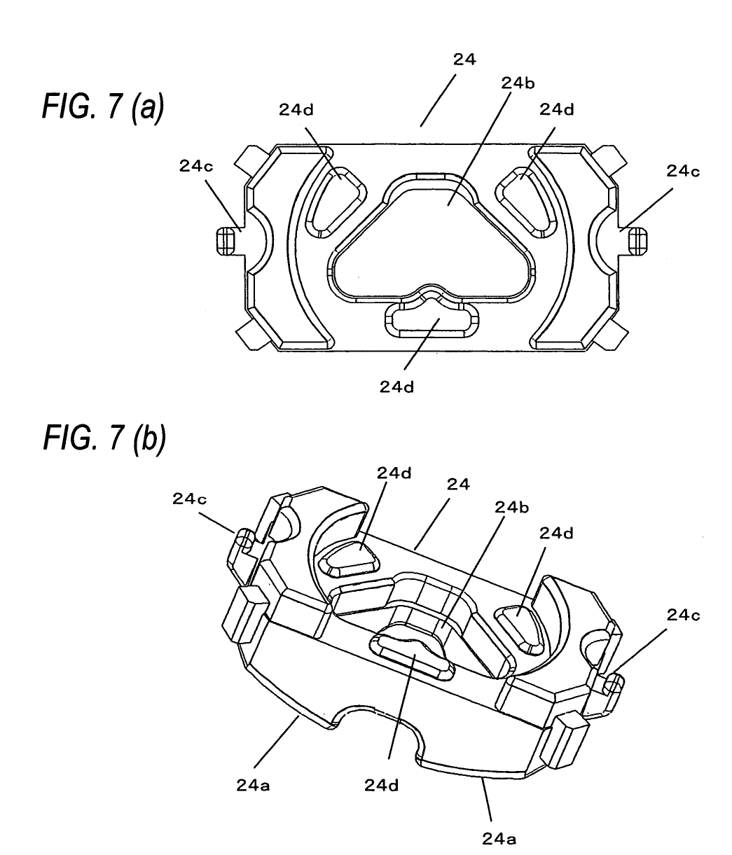

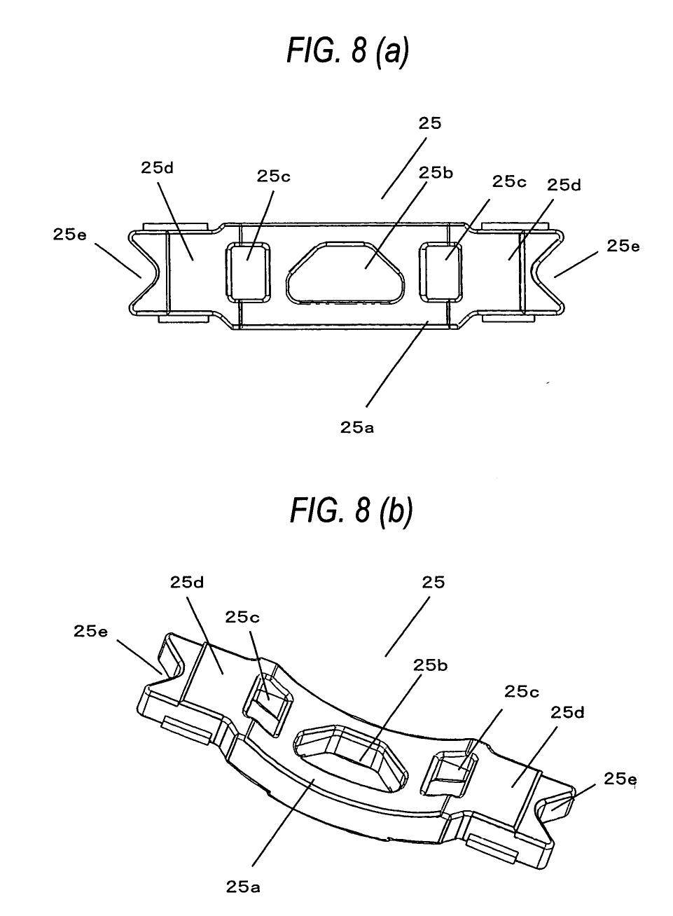

FIG. 1 is a view showing a structure of an optical system of an optical pick-up device according to a first embodiment. FIG. 2(a) is an exploded view showing a laser module according to the first embodiment and (b) is a view showing a structure of the laser module according to the first embodiment. FIG. 3 is a view showing an example of the optical pick-up device mounting components illustrated in FIGS. 1 and 2. FIG. 7(a) is a top view showing an adjusting member according to the first embodiment and (b) is a perspective view. FIG. 8(a) is a top view showing a laser beam source shift member according to the first embodiment and (b) is a perspective view.

First of all, description will be given to a structure of the optical pick-up device according to the first embodiment. The optical pick-up device according to the first embodiment can be used for both a CD and a DVD. A second laser beam source 10 having a wavelength λ2 of 780 nm is used for the CD and a first laser beam source 22 having a wavelength λ1 of 660 nm is used for the DVD. In the first embodiment, moreover, a laser module 1 is constituted to include the first laser beam source 22 as shown in FIGS. 1 and 2.

A reflecting mirror 2 has a total reflecting film formed in a specular portion of an optical member. Collimate lenses 3 and 9 are fabricated by optical glass or optical plastic, and a divergent light is converted into a parallel light, or contrarily, the parallel light is converted into a collected light. A beam splitter 4 is fabricated by optical glass or optical plastic and has a multilayer film (not shown) formed on a slant face therein. The multilayer film transmits most of a light emitted from the first laser beam 22, reflects most of a light emitted from the second laser beam source 10 and reflects all of lights reflected by an optical disk 8. A rising prism 5 is provided with a multilayer film (not shown) for reflecting both a light having the wavelength λ1 and a light having the wavelengths in a high reflectance. A hologram unit 6 is constituted by a polarizing hologram 6a and a ¼ wavelength plate 6b. The polarizing hologram 6a is fabricated by a material having a wavelength selectivity in order to act on only the light having the wavelength λ1. In the ¼ wavelength plate 6b, a refractive index and a thickness are set to act on both the wavelengths λ1 and λ2. An objective lens 7 is fabricated by optical glass or optical plastic and causes an optical disk 8 to collect a light. In the optical disk 8′, a CD system includes a CD, a CD-ROM and a CD-R/RW, and a DVD system includes a DVD-ROM, a DVD±R/RW and a DVD-RAM. Both the CD system and the DVD system can carry out recording and reproduction except for a read only medium.

A diffraction grating 11 is provided on the optical disk 8 side of the second laser beam source 10, and a light emitted from the second laser beam source 10 is divided into three laser beams to be used for a 3-beam tracking method. An integrated optical unit 12 is provided on the optical disk 8 side of the diffraction grating 11. The integrated optical unit 12 has a plurality of slant faces therein. A beam splitter (not shown) and a hologram (not shown) are formed on the slant face. The beam splitter divides the light having the wavelength λ2 emitted form the second laser beam source 10, the light having the wavelength λ1 reflected by the optical disk 8 and the light having the wavelength λ2 reflected by the optical disk 8. The hologram further divides the light having the wavelength λ2 reflected by the optical disk 8 which is divided. A photoreceptor 13 receives a light reflected by the optical disk 8 and outputs an electric signal for generating an RF signal, a tracking error signal or a focus error signal. A front light monitor 14 receives a light emitted from the first laser beam source 22 and reflected partially by the beam splitter 4 and a light emitted from the second laser beam source 10 and transmitted partially through the beam splitter 4 and outputs an electric signal corresponding to a quantity of the received light. The electric signal thus output is used for controlling an output of the laser beam.

Next, an optical path will be described. The laser beam having the wavelength λ1 which is emitted from the first laser beam source 22 is reflected by the reflecting mirror 2 so that an advance direction is changed, and a divergent light is converted into a parallel light by means of the collimate lens 3. The parallel light is transmitted through the beam splitter 4 and an advance direction is changed to be almost perpendicular to the optical disk 8 by means of the rising prism 5. The light having the advance direction changed by means of the rising prism 5 is transmitted through the hologram unit 6, and is then collected by the objective lens 7 and is irradiated on the optical disk 8.

The light reflected by the optical disk 8 passes through the objective lens 7, the hologram unit 6 and the rising prism 5 and is then reflected by the beam splitter 4, is collected by the collimate lens 9, and is thus incident on the integrated optical member 12. In the meantime, the polarizing hologram 6a of the hologram unit 6 divides the light reflected by the optical disk 8 into signal light components corresponding to an RF signal, a tracking error signal and a focus error signal. The light incident on the integrated optical member 12 is emitted from the second laser beam source 10 and is separated from the light reflected by the optical disk 8, and is incident on the photoreceptor 13.

On the other hand, the laser beam having the wavelength λ2 which is emitted from the second laser beam source 10 is transmitted through the integrated optical member 12 and is then converted into a parallel light by the collimate lens 9 and the parallel light is reflected by the beam splitter 4. Thereafter, the parallel light is reflected in the rising prism 5 and an advance direction is changed to be almost perpendicular to the optical disk 8, and the same light is transmitted through the hologram unit 6 and is then collected by the objective lens 7, and is thus irradiated on the optical disk 8.

The light reflected by the optical disk 8 passes through the objective lens 7, the hologram unit 6 and the rising prism 5 and is then reflected by the beam splitter 4, and is collected by the collimate lens 9 and is incident on the integrated optical member 12. The incident light is emitted from the first laser beam source 22 and is separated from the light reflected by the optical disk 8, and furthermore, is divided into a light corresponding to a RF signal, a tracking error signal or a focus error signal and is incident on the photoreceptor 13.

Next, description will be given to the laser module according to the first embodiment. In the first embodiment, the laser module 1 is constituted to include the first laser beam source 22. The first laser beam source 22 has a light emitting point 23 provided on a stem base 31 and serving to emit the laser beam having the wavelength λ1, and three leads 21 provided on an opposite side of an emitting portion 22a for emitting a laser beam and serving to supply a power to the first laser beam source 22. The light emitting point 23 is used for the laser beam seen from the emitting portion 22a. A cap 32 for protecting the emitting portion is attached to the laser beam source 22.

Adjusting position of the laser beam source so as to emit the laser beam in proper direction is called as adjusting repercussions, that is to say, it is tilt adjusting. Accordingly, a laser beam source adjusting member is called as a laser beam source tilt adjusting member.

A laser beam source adjusting member 24 is fabricated by a metal material such as a zinc die-cast, an aluminum die-cast or a magnesium die-cast. In the first embodiment, the zinc die-cast is used. As shown in detail in FIG. 7, the laser beam source adjusting member 24 has a first sliding surface 24a, a through hole 24b and two stoppers 24c. Moreover, a convex portion 24d for holding the stem base 31 of the first laser beam source 22 is provided around the through hole 24b. The first sliding surface 24a forms a part of a cylindrical plane in which the light emitting point 23 serves as a center of rotation when it is combined with the first laser beam source 22. The through hole 24b for inserting the lead 21 therethrough takes an almost triangular shape having such a size as not to come in contact with the lead 21. However, the through hole 24 does not need to take almost the triangular shape but three through holes may be provided corresponding to an arrangement of the three leads 21. Moreover, it is also possible to take a shape of a polygon other than an almost square, a chamfered square, an ellipse or a circle. If a point symmetrical shape is taken, the laser beam source adjusting member 24 is also attached to the first laser beam source 22 in a reverse direction so that manufacture can easily be carried out. The stopper 24c takes a shape of a hook so as to be hooked via a through hole 26a of a pressing member 26, thereby preventing the pressing member 26 from slipping off.

A laser beam source shift member 25 is fabricated by a metal material such as a zinc die-cast, an aluminum die-cast or a magnesium die-cast. In the first embodiment, the zinc die-cast is used. As shown in detail in FIG. 8, the laser beam source shift member 25 has a receiving plane 25a, a through hole 25b, a through hole 25c, a second sliding surface 25d and a V groove 25e. The receiving surface 25a is a cylindrical inner surface which has an almost equal radius to the radius of the first sliding surface 24a. The through hole 25b for inserting the lead 21 therethrough takes an almost triangular shape to have a slightly greater size than the through hole 24b of the laser beam source adjusting member 24 in such a manner that the lead 21 does not come in contact with the laser beam source shift member 25 even if the adjustment of the first laser beam source 22 is carried out around the light emitting point 23. However, the shape does not need to be an almost triangle but may be a polygon other than an almost square, a chamfered square, an ellipse or a circle. If a point symmetrical shape is taken, the laser beam source shift member 25 can also be attached to the first laser beam source 22 in a reverse direction so that manufacture can easily be carried out. The through hole 25c for inserting the pressing member 26 therethrough is an almost square hole having such a size that the pressing member 26 does not come in contact with the laser beam source shift member 25 even if the adjustment of the first laser beam source 22 is carried out around the light emitting point 23. The second sliding surface 25d is a plane which is pressed against a reference plane of an optical pick-up device body to carry out sliding. The V groove 25e is provided on both ends of the laser beam source shift member 25 and is used for holding the laser module 1 when the laser module 1 is incorporated in the optical pick-up device.

The pressing member 26 is a so-called plate spring and is fabricated by an elastic material such as beryllium copper, phosphor bronze, a steel plate for a spring, a stainless steel plate for a spring or a carbon steel plate for a spring. In the first embodiment, the beryllium copper is used. The pressing member 26 takes a U shape which is constituted by a bottom portion 26c and an arm portion 26d, and has a through hole 26a in the vicinity of open ends of both of the arm portions 26d and a through hole 26b in a bottom portion of the U shape. The through hole 26a is used for hooking and fixing the pressing member 26 to the stopper 24c. The through hole 26b for inserting the lead 21 therethrough takes an almost square shape having such a shape that the pressing member 26 does not come in contact with the lead 21 even if the adjustment of the first laser beam source 22 is carried out around the light emitting point 23. However, the shape does not need to be the almost square but may be an almost triangle, a polygon which is equivalent to or greater than an almost pentagon, a chamfered square, an ellipse or a circle. Since the shape is almost square and point symmetrical, the pressing member 26 can also be attached to the first laser beam source 22 in a reverse direction so that manufacture can easily be carried out.

An FPC 27 has one of sides connected to the lead 21 and the other side connected to a power supply (not shown) of the first laser beam source 22, and a predetermined power is supplied to the first laser beam source 22 through the FPC 27.

Next, description will be given to the fabrication of the laser module 1. First of all, the lead 21 of the first laser beam source 22 having a cap 32 attached thereto is inserted in the through hole 24b of the laser beam source adjusting member 24. Then, the stem base 31 is fixed to the convex portion 24d of the laser beam source adjusting member 24. In the first embodiment, the laser beam source adjusting member 24 is fixed to the first laser beam source 22 through soldering or bonding with an adhesive. A position of the laser beam source adjusting member 24 is opposite to the emitting portion 22a. The lead 21 penetrates the through hole 24b so as not to touch the laser beam source adjusting member 24. At this time, the first sliding surface 24a is a cylindrical plane setting the light emitting point 23 to be a center of rotation.

Then, the lead 21 is inserted in the through hole 25b of the laser beam source shift member 25, thereby pressing the first sliding surface 24a against the receiving surface 25a. The laser beam source shift member 25 is provided on the side of the laser beam source adjusting member 24 which is opposite to the first laser beam source 22. The receiving surface 25a is a cylindrical plane setting the light emitting point 23 to be a center of rotation and has an almost equal radius to the radius of the first sliding surface 24a. Therefore, the first sliding surface 24a and the receiving surface 25a can slide with each other. The lead 21 penetrates the through hole 25b so as not to touch the laser beam source shift member 25.

Subsequently, the lead 21 is inserted in the through hole 26b of the pressing member 26 and the arm portion 26d of the pressing member 26 is inserted in the through hole 25c of the laser beam source shift member 25, and the bottom portion 26c of the pressing member 26 is caused to come in contact with the bottom portion of the laser beam source shift member 25. Both ends of the bottom portion 26c are pressed to warp the bottom portion 26c, thereby causing both of the through holes 26a to penetrate the stoppers 24c. The pressing member 26 is provided on the side of the laser beam source shift member 25 which is opposite to the first laser beam source 22. The U-shaped arm portion 26d penetrates the through hole 25c and the two through holes 26a penetrate the stoppers 24c, respectively. The lead 21 penetrates the through hole 26b so as not to touch the pressing member 26. A length from the bottom portion 26c of the pressing member 26 to the through hole 26a is too short to insert both of the stoppers 24c in the through holes 26a in an non-assembly state. Since the pressing member 26 has an elasticity, however, it is possible to insert the stoppers 24c by warping the bottom portion 26c. Accordingly, the laser beam adjusting member 24 is supported on the laser beam source shift member 25 by an elastic force of the pressing member 26. For this reason, an appropriate load is applied between the first sliding surface 24a of the laser beam source adjusting member 24 and the receiving surface 25a of the laser beam source shift member 25 by the elastic force of the pressing member 26 so that sliding can be carried out freely. In the adjustment, the first sliding surface 24a and the receiving surface 25a are caused to slide. Consequently, the adjustment can be carried out smoothly.

Finally, the lead 21 is soldered and fixed to the FPC 27.

When the bottom portion 26c is to be warped to insert the through holes 26a in the stoppers 24c in the first embodiment, both ends of the bottom portion 26c are pressed. However, this is not restricted but the open ends of both of the arm portions 26d may be held and pulled to warp the bottom portion 26c. In that case, it is necessary to cause a length of the arm portion 26d to be sufficiently great for holding. Moreover, it is also possible to cut away a long unnecessary portion used for holding the arm portions 26d after inserting the stoppers 24c in the through holes 26a In order to easily carry out cutting, moreover, it is also possible to previously provide a notch in a portion to be cut.

Next, description will be given to the fabrication of the optical pick-up device. The second laser beam source 10, the diffraction grating 11, the integrated optical unit 12 and the photoreceptor 13 are previously subjected to a predetermined regulation and are assembled as an integral module. Furthermore, the integral module, the laser module 1 and the front light monitor 15 are connected through the FPC. Moreover, the objective lens 7 and the hologram unit 6 are integrally fixed as components of an actuator to the lens holder.

First of all, the rising prism 5, the reflecting mirror 2 and the beam splitter 4 are fixed to the optical pick-up device body. An ultraviolet curing adhesive is used for the fixation. Then, the collimate lenses 3 and 9 are attached to the optical pick-up device body movably in a direction of an optical axis. Thereafter, the laser module 1 connected through the FPC is arranged in a predetermined position of the optical pick-up device body.

Subsequently, the optical pickup device body mounting the laser module 1 is attached to a DVD optical axis regulating device. Before the attachment, the ultraviolet curing adhesive is previously applied to a predetermined part. A mechanism for detecting a laser beam emitted from the laser module 1 such as a CCD camera is mounted on the DVD optical axis regulating device. Referring to the laser module 1, a reference pin is inserted in the V groove 25e so that the laser beam source shift member 25 is held, and the FPC 27 is held so that the first laser beam source 22 fixed to the laser beam source adjusting member 24 is held. Moreover, the second sliding surface 25d is pushed against a reference plane (not shown) of the optical pickup device body.

First of all, a power is supplied to the first laser beam source 22 through the FPC 27 and the light emitting point 23 is thus caused to emit a light, and the collimate lens 3 is moved in the direction of the optical axis in such a manner that a laser beam emitted from the collimate lens 3 becomes an almost parallel light. Next, the laser beam source shift member 25 is slid in an X or Y direction shown in the drawing to carry out a regulation in such a manner that the detected light emitting point comes to a predetermined position on a monitor of the DVD optical axis regulating device. Then, a light intensity distribution of the detected laser beam is measured to carry out a regulation while rotating the first sliding surface 24 in a θx direction in such a manner that a direction of an emission of the laser beam and the optical axis are coincident with each other. The light emitting point 23 is a center of rotation of the first sliding surface 24. For this reason, the position of the light emitting point 23 is not changed. Finally, it is confirmed that the position of the light emitting point 23 is not shifted and the regulation is ended, and an ultraviolet ray is irradiated to cure the ultraviolet curing adhesive. The optical pick-up device is removed from the DVD optical axis regulating device. Then, a reinforcement may be further carried out with a thermal curing adhesive or an ultraviolet curing adhesive if necessary.

Subsequently, the second laser beam source 10 is incorporated in the CD optical axis regulating device to carry out a regulation and fixation in the same manner. Finally, an actuator is incorporated in the optical pick-up device body to regulate the position and inclination of the objective lens 7, and is fixed so that the optical pick-up device is finished.

In the optical pick-up device comprising the laser module 1 which is constituted and regulated as described above, the laser module 1 is incorporated in a small space of the optical pick-up device as shown in FIG. 3.

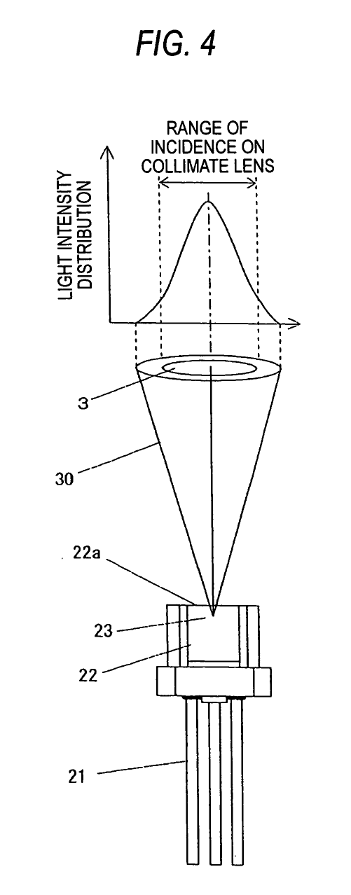

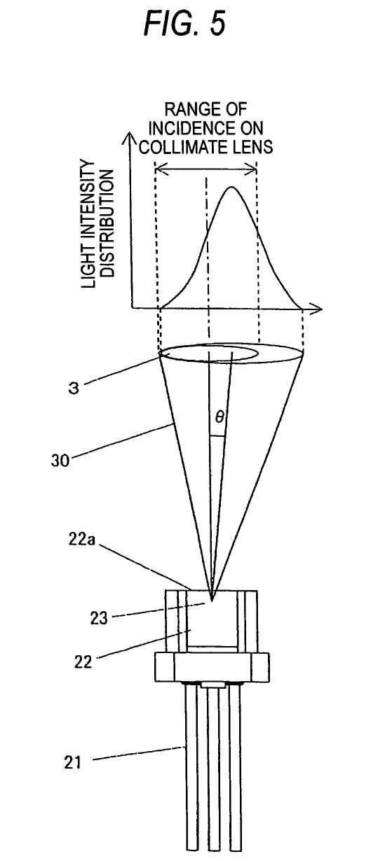

With reference to FIGS. 4 and 5, next, description will be given to a state in which the first laser beam source 22 is subjected to an adjustment so that the direction of the emission of the laser beam is regulated. FIG. 4 is a view showing a state of the emission of the laser beam in the case in which the direction of the emission of the laser beam is not inclined to the optical axis and a light intensity distribution with the collimate lens, and FIG. 5 is a view showing a state of the emission of the laser beam in the case in which the direction of the emission of the laser beam is inclined to the optical axis and the light intensity distribution with the collimate lens. The optical axis connects a center of the collimate lens 3 to that of the objective lens 7 along the optical path. In the case in which the direction of the emission of the laser beam is not inclined to the optical axis, a center of a light intensity of the optical beam 30 is coincident with the center of the collimate lens 3. Therefore, the quantity of the optical beam 30 emitted from the first laser beam source 22 and incident on the collimate lens 3 is maximized and the quantity of the light incident on the optical disk 8 is also maximized.

On the other hand, when the direction of the emission of the laser beam is inclined to the optical axis at an angle θ, the center of the intensity of the optical beam 30 is not coincident with that of the collimate lens 3. For this reason, the quantity of the optical beam 30 which is incident on the collimate lens 3 is more decreased as compared with the case in which the direction is not inclined to the optical axis. Consequently, the light incident on the optical disk 8 is also decreased.

In the first embodiment, the first laser beam source 22 is rotated around the light emitting point 23 together with the laser beam source adjusting member 24 and is thus adjusted, thereby carrying out a transition from the state shown in FIG. 5 to the state shown in FIG. 4. In addition, the first laser beam source 22 is moved in the X and Y directions with respect to the optical pick-up device body by means of the laser beam source shift member 25 together with the laser beam source adjusting member 24, thereby causing the center of the intensity of the laser beam 30 to be coincident with the center of the collimate lens 3.

In the first embodiment, the optical pick-up device can be caused to be used for both a CD and a DVD and the first laser beam source 22 for the DVD is set to be the laser module 1. However, the second laser beam source 10 for the CD may be set to be the laser module or both the first laser beam source 22 and the second laser beam source 10 may be set to be the laser modules. In addition, a combination with a so-called blue ray or an HDDVD may be applied. Moreover, it is also possible to use a laser beam source having a plurality of light emitting points close to each other, for example, a so-called 2-wavelength semiconductor laser beam source. Thus, the adjusting mechanism is provided in only a laser beam source requiring a position regulation and an adjustment and is thus set to be a laser module, and a laser beam source which does not require them does not need to be the laser module. Consequently, the optical pickup device can be smaller-sized and more inexpensive.

Although the first sliding surface 24a of the laser beam source adjusting member 24 is the cylindrical plane in the first embodiment, moreover, it is not restricted but may be a spherical surface. In that case, the adjustment can be carried out in the θx direction, and furthermore, a θy direction which is orthogonal thereto.

While the receiving surface 25a of the laser beam source shift member 25 is a cylindrical plane in the first embodiment, moreover, it is not restricted but another shape such as a so-called V shape may be employed. In that case, the first sliding surface 24a and the receiving surface 25a come in line contact with each other so that the influence of the entrance of dust can also be decreased. In the case in which the first sliding surface 24a is a spherical surface as described above, furthermore, the receiving surface 25a can also be a spherical surface or a shape combining a V shape can also be taken.

While the laser beam source adjusting member 24 and the laser beam source shift member 25 are coupled to each other by using the pressing member 26 in the first embodiment, furthermore, the pressing member 26 is not always necessary. For example, the laser module 1 itself may be pressed against the optical pickup device body, thereby carrying out the position regulation and the adjustment.

While the pressing member 26 has the property of the plate spring in the first embodiment, moreover, it is not restricted but the arm portion of the pressing member 26 may be replaced with a coil spring, for example. In that case, a bottom portion does not need to have the property of the plate spring. Moreover, the pressing member 26 may be fabricated by a magnet and the laser beam source adjusting member 24 and the laser beam source shift member 25 may be fabricated by a magnetic material, and they may be thus held by a magnetic force.

Since the optical pick-up device according to the first embodiment can carry out the position regulation and adjustment for the laser beam source, and furthermore, can decrease a space on the optical disk side of the laser beam source, thus, a size thereof can further be reduced. For this reason, it is possible to implement a smaller-sized and stable optical pick-up device for recording and reproduction.

### Second Embodiment

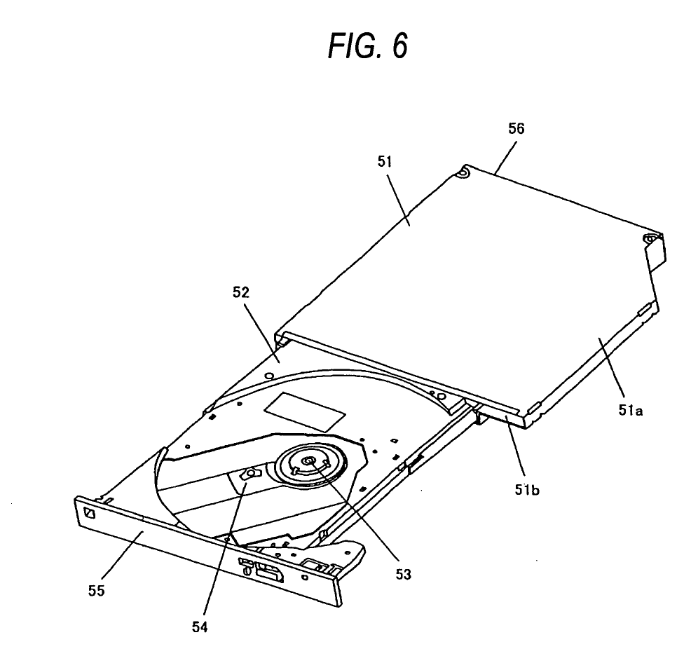

FIG. 6 is a perspective view showing an optical disk device according to a second embodiment. In FIG. 6, a housing 51 is constituted by combining an upper housing 51a with a lower housing 51b. A tray 52 is provided to freely appear from the housing 51. The tray 52 is provided with a spindle motor 53 to be rotating and driving means for rotating an optical disk 8 and an optical pickup device 54. The optical pick-up device 54 includes the laser module 1 described in the first embodiment and serves to carry out at least one of an operation for writing information to the optical disk 8 and an operation for reading the information from the optical disk 8. A first laser beam source 22 included in the laser module 1 executes a position regulation and an adjustment and a distribution of an intensity of a light incident on a collimate lens 3 at that time is shown in FIG. 4. Moreover, the tray 52 includes a feed driving system (not shown) to be moving means for causing the optical pick-up device 54 to approach the spindle motor 53 or separating the optical pick-up device 54 from the spindle motor 53. A bezel 55 is provided on a front end face of the tray 52 and is constituted to close the entrance of the tray 52 when the tray 52 is accommodated in the housing 51. A circuit board which is not shown is provided in the housing 51 and the tray 52, and an IC and a power circuit in a signal processing system are mounted thereon. An external connector 56 which is not shown is connected to a power/signal line provided in electronic equipment such as a computer. A power is supplied into an optical disk device through the external connector 56 or an electric signal is led from an outside into the optical disk device or an electric signal generated in the optical disk device is sent to external electronic equipment. The optical disk device mounting the optical pick-up device 54 including the laser module 1 described in the first embodiment can also be smaller-sized and can implement more stable recording and reproduction because the optical pick-up device 54 can be smaller-sized and can implement more stable recording and reproduction.

### Third Embodiment

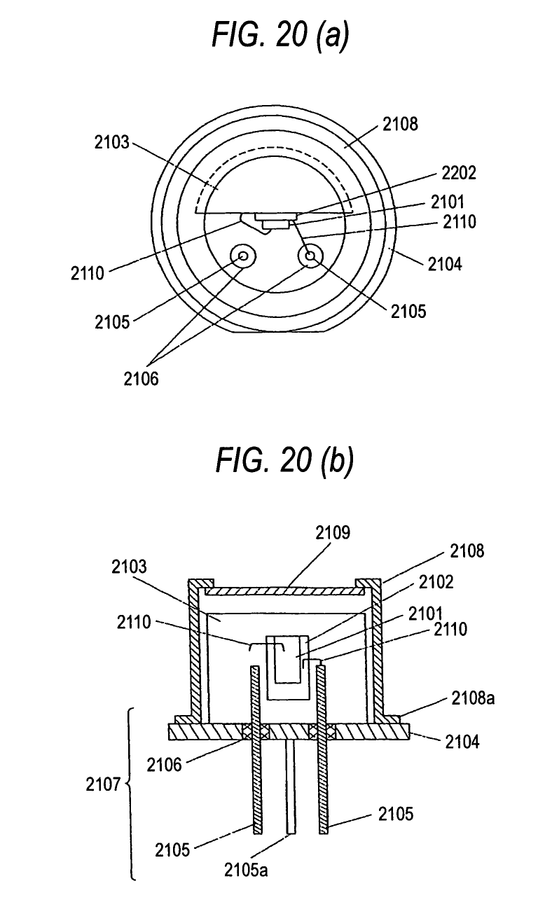

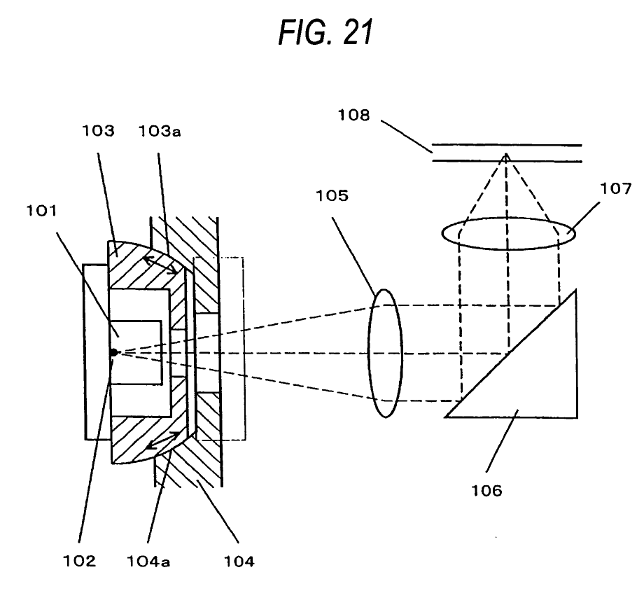

FIG. 20(a) is a top view showing a semiconductor laser device as a reference example and (b) is a sectional side view showing the semiconductor laser device as a reference example. A semiconductor laser device of a stem type has a structure shown in FIG. 20.

A laser unit 2101 is a laser diode and serves to emit a laser beam having a predetermined wavelength by a supply of a predetermined current. The laser unit 2101 is fixed to a submount 2102 by soldering. The submount 2102 is obtained by forming a film such as gold on a surface for fixing the laser unit 2101 formed by an insulating material such as aluminum nitride and a surface on an opposite side thereof. The submount 2102 is fixed to a block 2103 at a surface on an opposite side of the surface to which the laser unit 2101 is fixed. The block 2103 is formed of copper having an excellent thermal conduction. The block 2103 is fixed to a stem base 2104 of the stem 2107 by soldering. A heat generated in the laser unit 2101 is discharged from the stem base 2104 to an external space through the submount 2102 and the block 2103. In such a thermal conducting operation, the block 2103 serves as a heat sink.

The stem 2107 fixes a lead 2105 to the stem base 2104 through an insulator 2106 and fixes a lead 2105a to the stem base 2104 while maintaining an electrical connection to the stem base 2104. The stem base 2104 and the leads 2105 and 2105a have surfaces on which gold films are formed, respectively. The laser unit 2101 is connected to the leads 2105 and 2105a through a gold wire. The stem base 2104 is almost disk-shaped and a light emitting point of the laser unit 2101 is put on a central axis thereof.

A cap 2108 for a semiconductor laser is a can formed of a metal and a window portion 2109 (through hole) through which a laser beam passes is provided in a central part of a top portion, and a transparent plate such as glass is stuck to the window portion with an adhesive such as low-melting glass. The cap 2108 for a semiconductor laser is provided on the stem 2107 by welding through a flange 2108a disposed in an outer peripheral portion. In the welding, the cap 2108 for a semiconductor laser is welded so as not to touch the block 2103 in such a manner that the cap 2108 for a semiconductor laser can be prevented from pushing the block 2103, resulting in a deformation, a breakage or a positional or angular shift of the laser unit 2101 (see JP-A-2004-31900 Publication).

In recent years, a high-power semiconductor laser device has been required corresponding to an optical disk device capable of carrying out recording on a DVD. In the high-power semiconductor laser device, the amount of heat generation of the laser unit is also large. For this reason, it is necessary to efficiently radiate a heat generated in the laser unit so as to prevent a temperature from being raised to reach a compensation temperature. Therefore, it has been required to maintain a size of the block to be the heat sink.

On the other hand, a reduction in a thickness of the optical disk device has been required. In order to reduce the thickness of the optical disk device, it is necessary to reduce a thickness of the semiconductor laser device. For this purpose, it is required that a diameter of the cap for a semiconductor laser is decreased or at least a dimension in a direction of a thickness of the semiconductor laser device is decreased. However, the flange for the welding is provided in the outer peripheral portion of the cap for a semiconductor laser, and furthermore, the dimension has a margin in order to maintain a clearance from the block. For this reason, a reduction in the dimension of the cap for a semiconductor laser is limited. Moreover, the reduction in the dimension of the cap for a semiconductor laser in the direction of the thickness of the semiconductor laser device implies a reduction in a thickness and size of the block. In order to take a countermeasure against the heat of the laser unit, the reduction in the dimension of the cap for a semiconductor laser is limited.

If the cap for a semiconductor laser is not provided, it is possible to reduce the thickness of the semiconductor laser device. However, the laser unit and the gold wire are uncovered so that it is hard to carry out handling and to manufacture the optical pick-up device.

In a third embodiment which will be described below, such problems can be solved and it is possible to provide a cap for a semiconductor laser which can easily handle a semiconductor laser device and can correspond to an increase in an output and a reduction in a thickness.

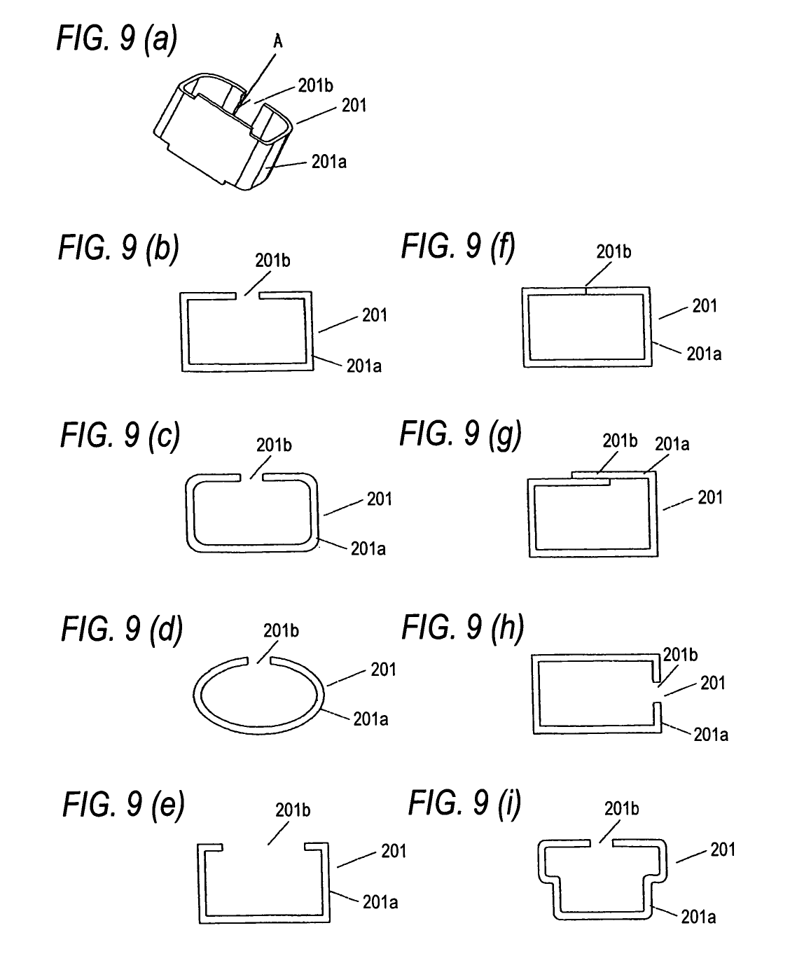

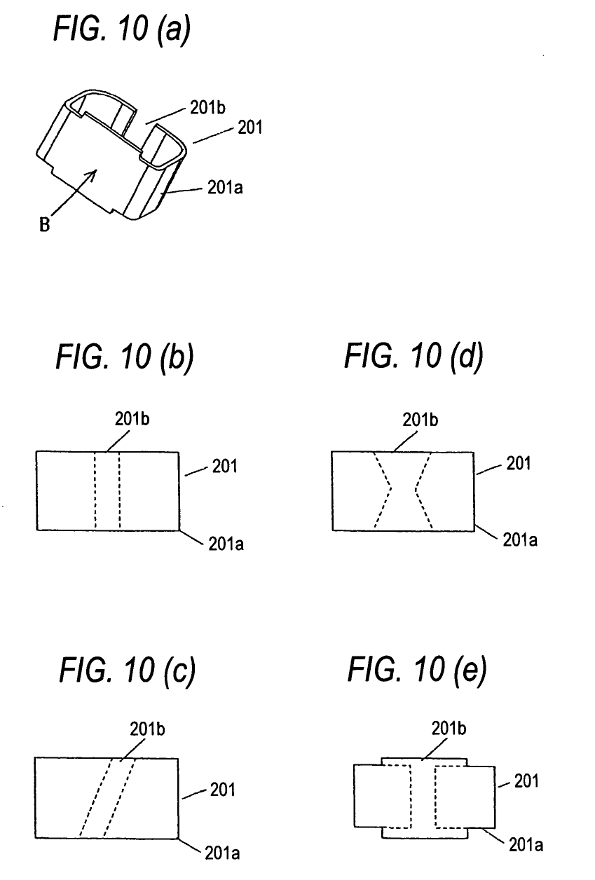

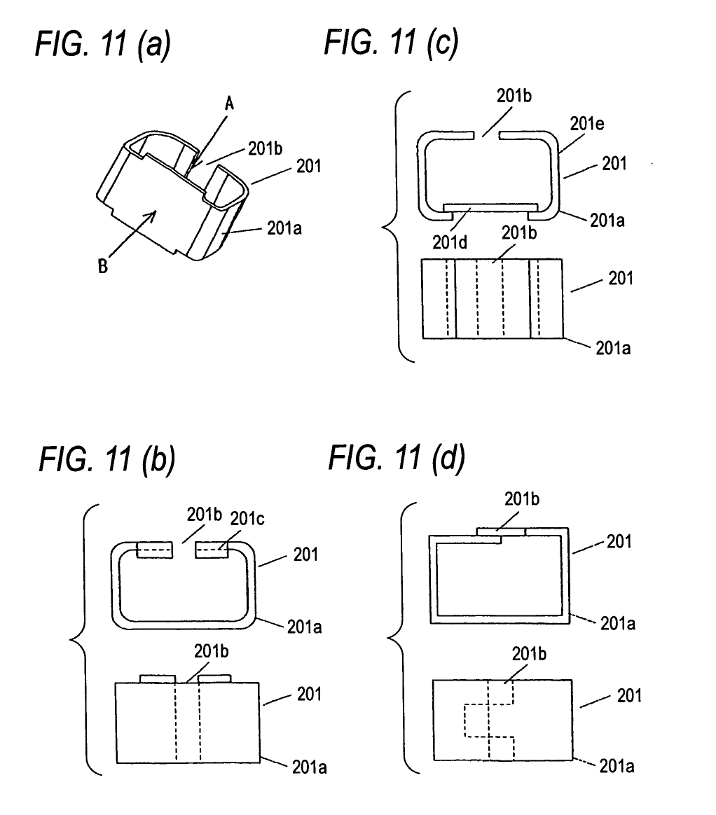

The third embodiment according to the invention will be described below with reference to the drawings. FIGS. 9(a), 10(a) and 11(a) are perspective views showing a shape of the cap for a semiconductor laser according to the third embodiment. FIGS. 9(b) to (i) are typical top views showing the cap for a semiconductor laser according to the third embodiment as seen in a direction of an arrow A in FIG. 9(a). FIGS. 10(b) to (e) are typical front views showing the cap for a semiconductor laser according to the third embodiment as seen in a direction of an arrow B in FIG. 10(a). FIGS. 11(b) to (d) are typical top and front views showing the cap for a semiconductor laser according to the third embodiment as seen in directions of arrows A and B in FIG. 11(a).

First of all, description will be given to a variation in a shape of a cap 201 for a semiconductor laser. The cap 201 for a semiconductor laser has a cylindrical member including a side surface portion 201a provided with a slip 201b, and the slit 201b is provided to penetrate from an upper end of the side surface portion 201a to a lower end thereof, and furthermore, a width in a circumferential direction of the slit 201b is smaller than a width in a circumferential direction of the side surface portion 201a projected in parallel with a surface of the slit 201b. The shape of the cylindrical member of the cap 201 for a semiconductor laser may be square as shown in FIG. 9(b), may be chamfered as shown in FIG. 9(c) and may be wholly curved as shown in FIG. 9(d). Moreover, the square is shown and is not restricted but a triangle, a pentagon and a hexagon may be used.

The width in the circumferential direction of the slit 201b may be greater as shown in FIG. 9(e) or may be almost zero as shown in FIG. 9(f). As shown in FIG. 9(g), furthermore, the side surface portions 201a may overlap each other. However, the width is smaller than the width in the circumferential direction of the side surface portion 201a projected in parallel with the surface of the slit 201b. The reason is that the cap 201 for a semiconductor laser is to be reliably attached to a block 204 as will be described below. Moreover, a position of the slit 201b may be placed in a side portion of the cap 201 for a semiconductor laser as shown in FIG. 9(h).

Moreover, the cap 201 for a semiconductor laser may take such a shape that a step is provided in a full width portion of the cap 201 for a semiconductor laser as shown in FIG. 9(i). In that case, the block 204 is interposed between portions having greater widths as will be described below.

If the slit 201b is provided to penetrate from an upper end face of the cap 201 for a semiconductor laser to a lower end face thereof, furthermore, the shape of the slit 201b may be vertical as shown in FIG. 10(b), may be oblique as shown in FIG. 10(c), and may have a width changed on an upper end or a lower end and a central part as shown in FIG. 10(d).

As shown in FIG. 10(e), moreover, a part of the lower end of the side surface portion 201a may be taken away. The reason is that a stem 208 is soldered to the block 204, and the protruded soldering material is taken away so that the cap for a semiconductor laser can be prevented from touching the soldering material as will be described below. Consequently, the cap 201 for a semiconductor laser is reliably attached to the block 204, and furthermore, a residual portion obtained after cutout is attached to come in contact with the step 208 so that positioning in a direction of a height of the cap for a semiconductor laser can be carried out. To the contrary, in the case in which a notch is not provided, there is a possibility that the cap 201 for a semiconductor laser might get over the soldering material. However, the shape of the cap 201 for a semiconductor laser is simplified. Consequently, it is possible to reduce a manufacturing cost of the cap 201 for a semiconductor laser.

As shown in FIGS. 10(a) to (e), moreover, it is desirable that the cap 201 for a semiconductor laser should be constituted to be vertically symmetrical or vertically rotation symmetrical. The reason is that the upper and lower parts of the cap 201 for a semiconductor laser are not distinguished, and therefore, are not mistaken when the semiconductor laser device is to be manufactured. In the case in which the notch is provided in only a bottom portion and the cap 201 for a semiconductor laser is not vertically symmetrical or vertically rotation symmetrical, however, there is a possibility that the upper and lower parts of the cap 201 for a semiconductor laser might be mistaken when the semiconductor laser device is to be manufactured. However, it is possible to reduce the manufacturing cost of the cap 201 for a semiconductor laser.

Referring to the shape of the cap 201 for a semiconductor laser, a part of the upper end of the side surface portion 201a may be bent to form a fin portion 201c perpendicularly to the side surface portion 201a as shown in FIG. 11(b). Moreover, the side surface portion 201a may be constituted by separate components of a base portion 201d and an arm portion 201e as shown in FIG. 11(c) or the width in the circumferential direction of the slit 201b may be obtained by combining a positive portion with a negative portion as shown in FIG. 11(d).

Description will be given to a method of fabricating the cap 201 for a semiconductor laser. The cap 201 for a semiconductor laser is partially or wholly fabricated by a material having an elasticity such as phosphor bronze, beryllium copper, SUS or titanium. Moreover, the cap 201 for a semiconductor laser may be fabricated by a bimetal such as invar-brass. Moreover, it may be fabricated by a shape memory alloy such as nickel-titanium or a copper-aluminum-nickel alloy. In addition, it can also be fabricated by a metal such as aluminum, iron or copper or an alloy based thereon. Moreover, a metal film may be formed on a resin material. For a film forming method, it is possible to use various methods such as electrolytic plating, nonelectrolytic plating, vacuum deposition and a sputtering method. As shown in FIG. 11(c), furthermore, the side surface portion 201a can also be constituted by the separate components of the base portion 201d and the arm portion 201e. In this case, the base portion 201d can be formed by a metal material and the arm portion 201e may be formed of a resin having a metal film provided thereon, for example.

The cylindrical member is obtained by forming a plate member cylindrically using a method such as pressing.

### Fourth Embodiment

A fourth embodiment according to the invention will be described below.

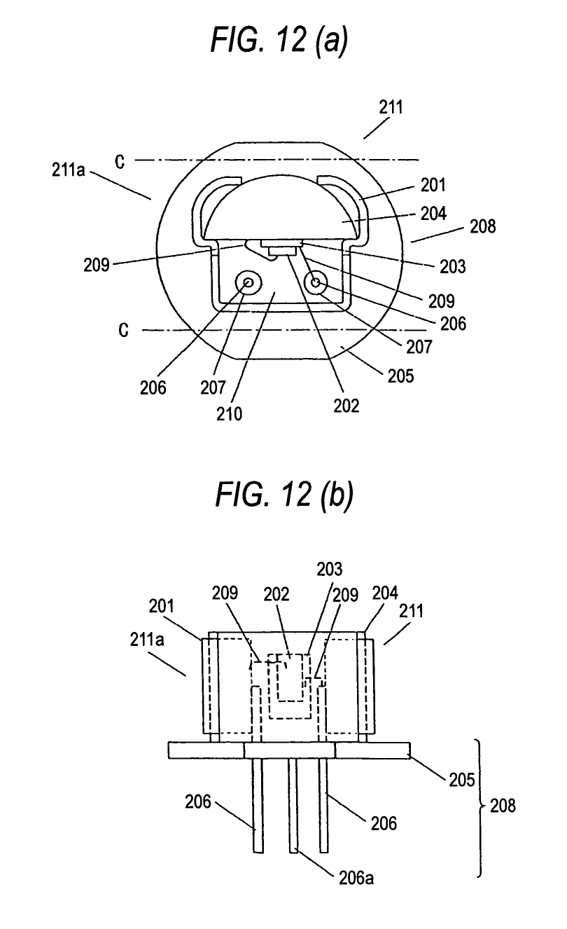

FIG. 12(a) is a top view showing a semiconductor laser device using the cap for a semiconductor laser described in the third embodiment according to the fourth embodiment, and FIG. 12(b) is a front view showing the same. A material of a cap 201 for a semiconductor laser is phosphor bronze to be an elastic member. The cap 201 for a semiconductor laser takes a top shape shown in FIG. 9(i) and a front shape shown in FIG. 10(e). In an attachment, a lower end of a side surface portion 201a of the cap 201 for a semiconductor laser in the vicinity of a block 204 is taken away. Moreover, an upper end is also taken away to take the same shape to be vertically symmetrical. A width in such a direction as to expand a slit 201b of the cap 201 for a semiconductor laser is set to be slightly smaller than a dimension in a transverse direction of the block 204 to be combined

First of all, description will be given to a structure of a semiconductor laser beam source 211a. The cap 201 for a semiconductor laser is attached to the semiconductor laser beam source 211a so that a semiconductor laser device 211 is constituted. A laser unit 202 is a laser diode and emits a laser beam having a predetermined wavelength by a supply of a predetermined current. While the laser unit 202 is used for a DVD for emitting a laser beam having a wavelength of 660 nm in the fourth embodiment, it may be used for a CD for emitting a laser beam having a wavelength of 780 nm or may be a so-called 2-wavelength semiconductor laser unit for emitting a laser beam having both wavelengths of 660 nm and 780 nm. Furthermore, the laser unit 202 may be a laser unit for a so-called blue ray or an HDDVD. While the laser unit 202 is a high power laser unit capable of carrying out recording on an optical disk, moreover, it may be a low power laser unit which cannot carry out the recording.

A submount 203 is fabricated by a material having an insulating property and a high thermal conductivity such as aluminum nitride or silicon carbide. The submount 203 is an almost rectangular parallelepiped and a film of gold is formed on a surface to which the laser unit 202 is fixed and a surface to which the block 204 is fixed.

The block 204 is fabricated by a material having a high thermal conductivity such as copper or a copper alloy and a film of gold is formed on a surface A heat generated by the laser unit 202 is discharged from a stem base 205 to an external space via the submount 203 and the block 204. The block is thick in order to sufficiently serve as a heat sink in such a thermal conducting operation.

The stem base 205 is fabricated by an iron type metal material taking an almost oval shape, and a film of gold is formed on a surface. The oval shape is obtained by cutting a disk-shaped string and the thickness of the semiconductor laser device 211 is thus reduced. Two holes for providing a lead 206 are formed on a surface of the stem base 205.

Leads 206 and 206a are thin electrode rods in which a film of gold is formed on a surface of an iron type metal material. An insulator 207 has an insulating property such as soft glass and is constituted by a material capable of fixing the stem base 205 to the lead 206. A step 208 is obtained by providing the leads 206 and 206a on the stem base 205.

A gold wire 209 is used for the wire bonding of a semiconductor laser.

Next, description will be given to an example of a method of fabricating the semiconductor laser beam source 211a. First of all, the laser unit 202 is fixed to the submount 203 by a solder. The solder for soldering includes gold tin. Subsequently, the submount 203 is fixed to the block 204 by the solder. The solder for soldering includes tin silver having a lower melting point than the melting point of the gold tin. Then, the block 204 is fixed to the stem 208 by soldering.

On the other hand, the step 208 is fabricated by the following method. The lead 206 is inserted through the hole of the stem base 205, and furthermore, ring-shaped soft glass is put in the position of the hole and is heated and molten and then cooled to fix the lead 206 in an insulating state from the stem base 205. Moreover, the lead 206a is fixed to the stem base 205 by welding.

After the block 204 is fixed to the stem 208 by the soldering, either the laser unit 202 and the block 204 or the submount 203 and the lead 206 are connected through the wire bonding by using the gold wire 209, for example.

Next, description will be given to a method of attaching the cap 201 for a semiconductor laser. First of all, the slit 201b of the cap 201 for a semiconductor laser is expanded in a circumferential direction by utilizing an elasticity. Then, the cap 201 for a semiconductor laser is put on the block 204 in a predetermined direction and is brought downward to abut on the stem base 205. A force for expanding the slit 201b is released. A width in such a direction as to expand the slit 201b of the cap 201 for a semiconductor laser is set to be slightly smaller than a width in the circumferential direction of the block 204 to be combined. Therefore, the cap 201 for a semiconductor laser is held in such a state that the width in the circumferential direction of the slit 201b is slightly increased. The cap 201 for a semiconductor laser applies a force in an internal direction of the block 204 on at least three contact points with the block 204. If it is balanced, the cap 201 for a semiconductor laser is attached to and held in the block 204. In the fourth embodiment, the cap 201 for a semiconductor laser comes in contact with the block 204 on four points and is attached to and held in the block 204 by an elastic force thereof.

The cap 201 for a semiconductor laser is provided with a step in a full width portion of the cap 201 for a semiconductor laser and is provided with a space portion 210 together with the block 204. A width of the space portion 210 is smaller than that of the block 204 through the step. Therefore, the space portion 210 can be provided in a predetermined position with respect to the block 204. Moreover, the space portion 210 is provided between a side surface portion 201a and the block 204. The space portion 210 accommodates the laser unit 202, the submount 203, the lead 206 and the gold wire 209 therein.

In the cap 201 for a semiconductor laser, the lower end of the side surface portion 201a to be in the vicinity of the block 204 in an attachment is taken away. Therefore, the attachment can be carried out so as not to come in contact with the soldering material protruded by the soldering of the stem 208 and the block 204. By bringing a portion which is not taken away downward to come in contact with the stem base 205, moreover, positioning in the direction of the height with respect to the stem base 205 and the block 204 can also be carried out. Furthermore, an upper end of the side surface portion 201a of the cap 201 for a semiconductor laser is also taken away in the same shape to be vertically symmetrical (vertically rotation symmetrical). When attaching the cap 201 for a semiconductor laser to the block 204, therefore, it is possible to carry out a work without caring about the upper and lower parts of the cap 201 for a semiconductor laser.

In the fourth embodiment, a side surface of the stem base 205 has a width of approximately 1 mm and it is hard to hold and handle the same portion. However, the laser unit 202 is surrounded by the cap 201 for a semiconductor laser and the block 204. Therefore, the cap 201 for a semiconductor laser can be held for easy handling. Moreover, the cap 201 for a semiconductor laser is attached to the block 204 by an elastic force. For this reason, there is not required a clearance between the flange 2108a for welding and the cap 2108 for a semiconductor laser, and the block 2103 shown in FIG. 20 as a reference example. Consequently, it is possible to reduce the thickness of the semiconductor laser device 211 as shown in a line C of FIG. 12(a) without reducing a thickness and a size of the block 204. As described above, the semiconductor laser device according to the fourth embodiment is easy to handle and can correspond to an increase in an output and a reduction in a thickness.

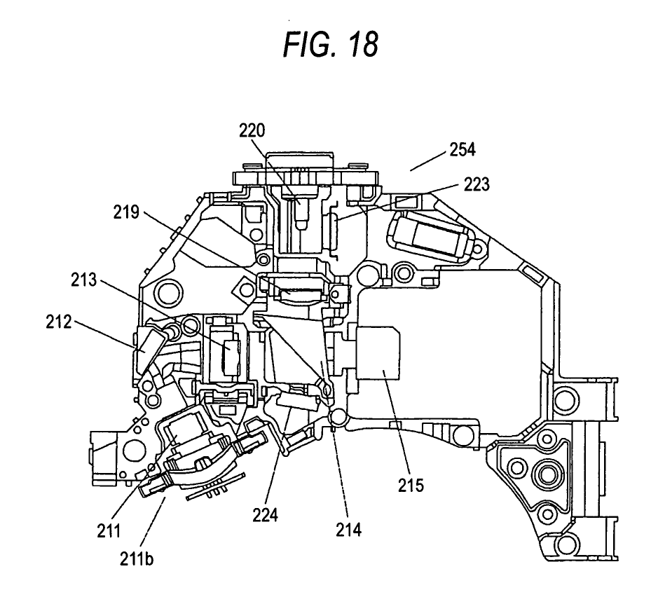

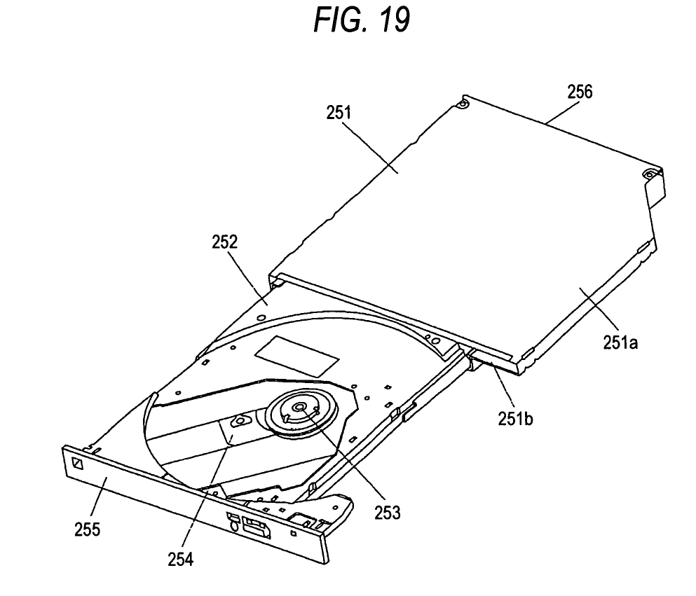

In an assembly as an optical pick-up device 254 shown in FIG. 18, furthermore, an adhesive for bonding a first semiconductor laser device 211 to an optical pick-up device 254 body or a heat radiating grease for efficiently radiating a heat generated from the laser unit 202 is present around the first semiconductor laser device 211. There is also a possibility that they might contaminate the laser unit 202 in a state in which the cap 201 for a semiconductor laser is not provided. By providing the cap 201 for a semiconductor laser, however, it is also possible to obtain the effect of preventing the contamination.

In the fourth embodiment, the phosphor bronze to be the elastic member is used as the material of the cap 201 for a semiconductor laser. However, it is not restricted but a material obtained by forming a metal film on a resin material may be used. In that case, a weight can be reduced more greatly as compared with the case in which the cap 201 for a semiconductor laser is constituted by a metal material.

### Fifth Embodiment

In a fifth embodiment, a material of a cap 201 for a semiconductor laser is set to be a bimetal of invar-brass and a side surface portion 201a has an inner peripheral side formed of brass and an outer peripheral side formed of invar. Since the cap 201 for a semiconductor laser takes the same top and front shapes in FIGS. 9(i) and 10(e) as those in the third embodiment and a semiconductor laser beam source 211a is the same as that in the fourth embodiment, description thereof will be incorporated.

When the cap 201 for a semiconductor laser is to be attached to a block 204, it is heated to approximately 200 □. In the cap 201 for a semiconductor laser, the brass on the inner peripheral side is swollen more greatly and a slit 201b of the cap 201 for a semiconductor laser is expanded by an action of a bimetal. In that state, the cap 201 for a semiconductor laser is attached to the block 204 so that the heating is ended. The temperature of the cap 201 for a semiconductor laser is lowered and a width in such a direction as to expand the slit 201b of the cap 201 for a semiconductor laser is set to be slightly smaller than a dimension in a transverse direction of the block 204 to be combined. For this reason, the cap 201 for a semiconductor laser is held in a state in which a width in a circumferential direction of the slit 201b is expanded slightly. While the cap 201 for a semiconductor laser is attached to and held in the block 204 by an elastic force in the fourth embodiment, it is attached to and held in the block 204 by such a force that the bimetal is contracted to take an original shape in the fifth embodiment.

### Sixth Embodiment

In a sixth embodiment, a shape memory alloy such as a nickel-titanium alloy is used for a material of a cap 201 for a semiconductor laser. In that case, an operation set temperature is set to be 50 □, for example. Since the cap 201 for a semiconductor laser takes the same top and front shapes in FIGS. 9(i) and 10(e) as those in the third embodiment and a semiconductor laser beam source 211a is the same as that in the fourth embodiment, description thereof will be incorporated.

After the cap 201 for a semiconductor laser is finished, a slip 201b is expanded in a circumferential direction before an attachment to a block 204. After the attachment to the block 204 in that state, heating is carried out to 50 □ or more. By shape memory effect, consequently, the cap 201 for a semiconductor laser tries to return to a shape obtained before the expansion of the slit 201b in the circumferential direction and is attached to and held in the block 204 by the same force.

### Seventh Embodiment

In a seventh embodiment, copper is used for a material of a cap 201 for a semiconductor laser. Since the cap 201 for a semiconductor laser takes the same top and front shapes in FIGS. 9(i) and 10(e) as those in the third embodiment and has such a size as to be adapted to a block 204 at the beginning and a semiconductor laser beam source 211a is the same as that in the fourth embodiment, description thereof will be incorporated.

An adhesive is used for attaching and holding the cap 201 for a semiconductor laser. The adhesive may be of an ultraviolet irradiation curing type, a heat curing type or an anaerobic type. The cap 201 for a semiconductor laser is attached into a predetermined position and the adhesive is applied and cured. The adhesive may be applied before the cap 201 for a semiconductor laser is attached.

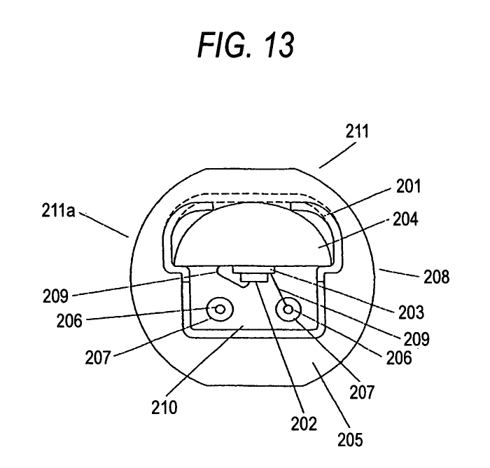

FIG. 13 is a view showing a difference in an attachment state depending on the presence of a slit in the case in which the attachment is carried out by using the adhesive in the seventh embodiment. In the case in which a slit 201b is not present, the cap 201 for a semiconductor laser is placed in a position shown in a dotted line. On the other hand, in the case in which the slit 201b is present, a width in a circumferential direction of the slit 201b can be increased. Therefore, a thickness of the semiconductor laser device 211 can further be reduced corresponding to a thickness of a side surface portion 201a of the cap 201 for a semiconductor laser as compared with the case in which the slit 201b is not present.

### Eighth Embodiment

In an eighth embodiment, a shape of a cap 201 for a semiconductor laser is based on the shape in which the fin portion 201c is provided as shown in FIG. 11(b), and the step in FIG. 9(i) is provided. Phosphor bronze is used for a material. Since a semiconductor laser beam source 211a is the same as that in the fourth embodiment, description thereof will be incorporated.

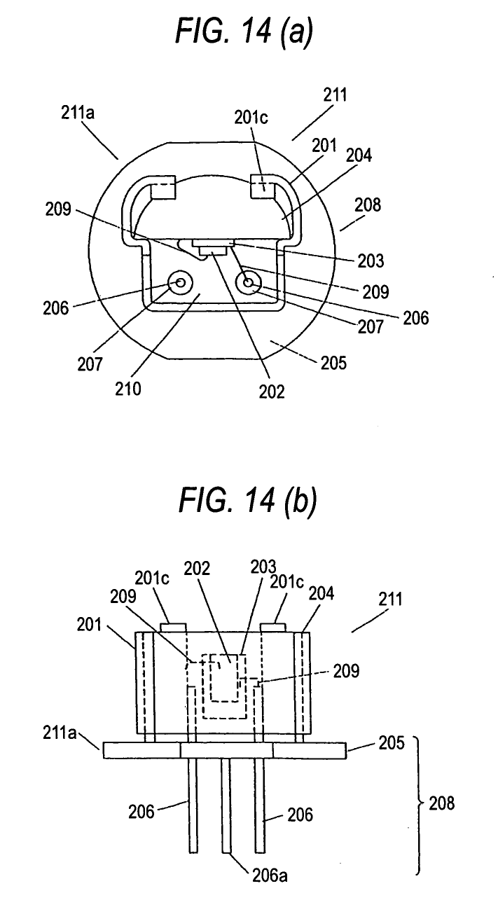

FIG. 14(a) is a top view showing a semiconductor laser device according to the eighth embodiment and FIG. 14(b) is a front view showing the same. A method of attaching the cap 201 for a semiconductor laser is as follows. First of all, a slit 201b of the cap 201 for a semiconductor laser is expanded in a circumferential direction. Next, the cap 201 for a semiconductor laser is put on a block 204 in a predetermined direction and is brought downward to abut on an upper surface of the block 204. A force for expanding the slit 201b is released. By causing the fin portion 201c to abut on the upper surface of the block 204, thus, it is possible to position the cap 201 for a semiconductor laser in a direction of a height with respect to the block 204.

### Ninth Embodiment

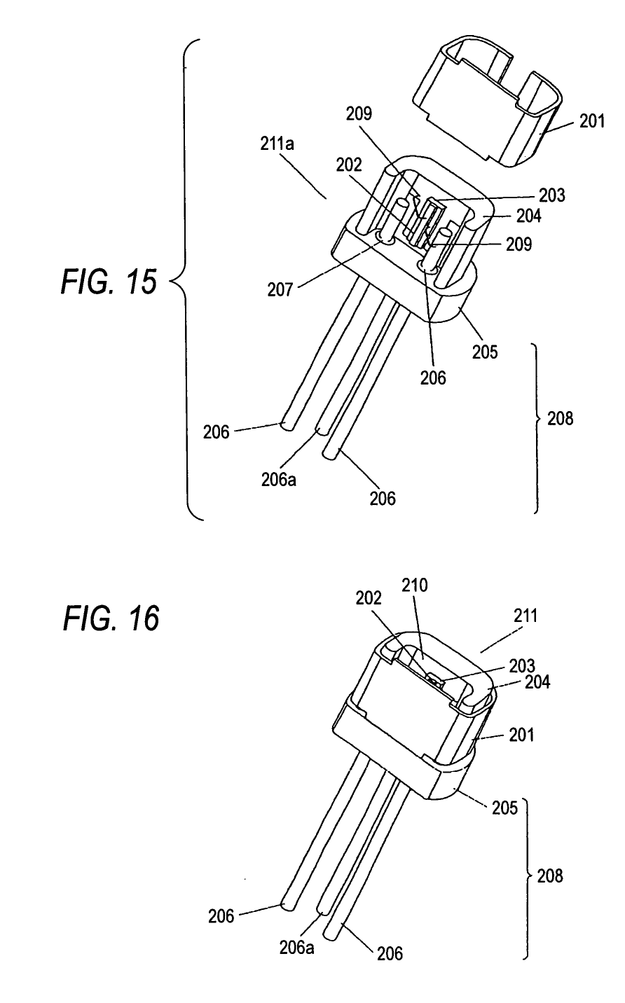

A ninth embodiment according to the invention will be described below with reference to the drawings. FIG. 15 is an exploded view showing a semiconductor laser device according to the ninth embodiment and FIG. 16 is a view showing a structure of the semiconductor laser device according to the ninth embodiment.

In the ninth embodiment, there is used a semiconductor laser beam source 211a (Mitsubishi Electric Corporation, Product Number ML10223-44) in which a block 204 takes a U shape obtained by extending an arm portion from both sides of a bottom portion and a laser unit 202, a submount 203, a lead 206 and a metal wire 209 are provided on an inside thereof. There is used a semiconductor laser device 211 having such a structure that a cap 201 for a semiconductor laser having a top shape in FIG. 9(c) and a front shape in FIG. 10(e) is attached to the semiconductor laser beam source 211a. The U-shaped bottom portion of the block 204 is thick in order to serve as a sufficient heat sink. Since other structures are the same as those in the fourth embodiment, description thereof will be incorporated.

Next, description will be given to a method of attaching the cap 201 for a semiconductor laser. First of all, the slit 201b of the cap 201 for a semiconductor laser is expanded in a circumferential direction by utilizing an elasticity. Then, the cap 201 for a semiconductor laser is put on the block 204 in a predetermined direction and is brought downward to abut on the stem base 205. A force for expanding the slit 201b is released. Thus, the attaching method is the same as that in the fourth embodiment.

In the fourth embodiment, a side surface 201a of the cap 201 for a semiconductor laser surrounds the three directions of the space portion 210 for accommodating the laser unit 202 therein. In the ninth embodiment, the cap 201 for a semiconductor laser simply surrounds one of the directions of the space portion 210. In any case, a whole periphery of the laser unit 202 is surrounded by a side surface portion 201a of the cap 201 for a semiconductor laser and the block 204. Therefore, the cap 201 for a semiconductor laser can be held for easy handling. Moreover, the cap 201 for a semiconductor laser is attached to the block 204 by an elastic force. For this reason, there is not required a clearance between the flange 2108a for welding and the cap 2108 for a semiconductor laser, and the block 2103 shown in FIG. 20 as a reference example. Consequently, it is possible to reduce the thickness of the semiconductor laser device 211 without reducing a thickness and a size of the block 204. As described above, the semiconductor laser device according to the ninth embodiment is also easy to handle and can correspond to an increase in an output and a reduction in a thickness.

While the material of the cap 201 for a semiconductor laser is set to be the elastic member in the ninth embodiment, the same advantages can be obtained even if a bimetal is used, and furthermore, the shape memory alloy and other materials may be used.

### Tenth Embodiment

A tenth embodiment according to the invention will be described below with reference to the drawings. In the tenth embodiment, description will be given to an optical pick-up device 254 comprising the semiconductor laser device 211 as a first semiconductor laser device.

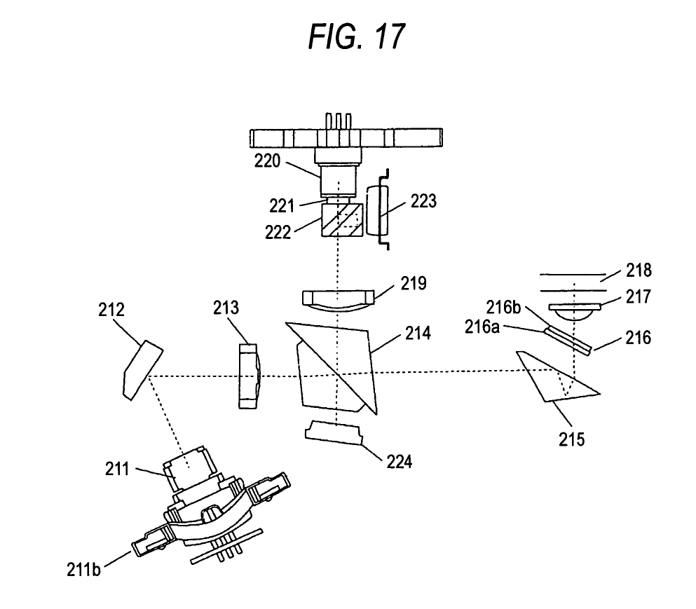

FIG. 17 is a view showing a structure of an optical system of the optical pick-up device according to the tenth embodiment. FIG. 18 is a view showing an appearance of the optical pick-up device according to the tenth embodiment using the optical system of FIG. 17.

First of all, description will be given to a structure of an optical system of the optical pick-up device 254 according to the tenth embodiment. The optical pick-up device 254 according to the tenth embodiment can carry out recording and reproduction by both a CD and a DVD. A second semiconductor laser device 220 having a wavelength λ2 of 780 nm, capable of carrying out both recording and reproduction and having a high power is used for the CD and a first semiconductor laser device 211 having a wavelength λ1 of 660 nm, capable of carrying out both recording and reproduction and having a high power is used for the DVD. A semiconductor laser device provided in the optical pick-up device 254 according to the tenth embodiment is set to be a first semiconductor laser device 211. The first semiconductor laser device 211 is used as a laser module 211b in a combination with a posture and position regulating member. The semiconductor laser device 211 according to the tenth embodiment corresponds to the first laser beam source 22 according to the first and second embodiments, the posture and position regulating member according to the tenth embodiment corresponds to the laser beam source adjusting member 24 and the laser beam source shift member 25 according to the first and second embodiments, and furthermore, the laser module 211b according to the tenth embodiment corresponds to the laser module 1 according to the first and second embodiments.

A reflecting mirror 212 has a total reflecting film formed in a specular portion of an optical member. Collimate lenses 213 and 219 are fabricated by optical glass or optical plastic, and a divergent light is converted into a parallel light, or contrarily, the parallel light is converted into a collected light. A beam splitter 214 is fabricated by optical glass or optical plastic and has a multilayer film (not shown) formed on a slant face therein. The multilayer film transmits most of a light emitted from the first semiconductor laser device 211, reflects most of a light emitted from the second semiconductor laser device 220 and reflects all of lights reflected by an optical disk 218. A rising prism 215 is provided with a multilayer film (not shown) for reflecting both a light having the wavelength λ1 and a light having the wavelength λ2 in a high reflectance. A hologram unit 216 is constituted by a polarizing hologram 216a and a ¼ wavelength plate 216b. The polarizing hologram 216a is fabricated by a material having a wavelength selectivity in order to act on only the light having the wavelength λ1. In the ¼ wavelength plate 216b, a refractive index and a thickness are set to act on both the wavelengths λ1 and λ2. An objective lens 217 is fabricated by optical glass or optical plastic and causes the optical disk 218 to collect a light. In the optical disk 218, a CD system includes a CD, a CD-ROM and a CD-R/RW, and a DVD system includes a DVD-ROM, a DVD±R/RW and a DVD-RAM. Both the CD system and the DVD system can carry out recording and reproduction except for a read only medium.

A diffraction grating 221 is provided on the optical disk 218 side of the second semiconductor laser device 220, and a light emitted from the second semiconductor laser device 220 is divided into three laser beams to be used for a 3-beam tracking method. An integrated optical unit 222 is provided on the optical disk 218 side of the diffraction grating 221. The integrated optical unit 222 has a plurality of slant faces therein. A beam splitter (not shown) and a hologram (not shown) are formed on the slant face. The beam splitter divides the light having the wavelength λ2 emitted from the second semiconductor laser device 220, the light having the wavelength λ1 reflected by the optical disk 218 and the light having the wavelength λ2 reflected by the optical disk 218. The hologram further divides the light having the wavelength λ2 reflected by the optical disk 218 which is divided. A first light receiving portion 223 receives a light reflected by the optical disk 218 and outputs an electric signal for generating an RF signal, a tracking error signal or a focus error signal. A second light receiving portion 224 receives a light emitted from the first semiconductor laser device 211 and reflected partially by the beam splitter 214 and a light emitted from the second semiconductor laser device 220 and transmitted partially through the beam splitter 214 and outputs an electric signal corresponding to a quantity of the received light. The electric signal thus output is used for controlling an output of the laser beam.

Next, an optical path will be described. The laser beam having the wavelength λ1 which is emitted from the first semiconductor laser device 211 is reflected by the reflecting mirror 212 so that an advance direction is changed, and a divergent light is converted into a parallel light by means of the collimate lens 213. The parallel light is transmitted through the beam splitter 214 and an advance direction is changed to be almost perpendicular to the optical disk 218 by means of the rising prism 215. The beam having the advance direction changed by means of the rising prism 215 is transmitted through the hologram unit 216 and is then collected by the objective lens 217, and is irradiated on the optical disk 218.

The light reflected by the optical disk 218 passes through the objective lens 217, the hologram unit 216 and the rising prism 215 and is then reflected by the beam splitter 214, is collected by the collimate lens 219, and is thus incident on the integrated optical member 222. In the meantime, the polarizing hologram 216a of the hologram unit 216 divides the light reflected by the optical disk 218 into signal light components corresponding to an RF signal, a tracking error signal and a focus error signal. The light incident on the integrated optical member 222 is emitted from the second semiconductor laser device 220 and is separated from the light reflected by the optical disk 218, and is incident on the first light receiving portion 223.

On the other hand, the laser beam having the wavelength λ2 which is emitted from the second semiconductor laser device 220 is transmitted through the integrated optical member 222 and is then converted into a parallel light by the collimate lens 219 and the parallel light is reflected by the beam splitter 214. Thereafter, the parallel light is reflected in the rising prism 215 and an advance direction is changed to be almost perpendicular to the optical disk 218, and the same light is transmitted through the hologram unit 216 and is then collected by the objective lens 217, and is thus irradiated on the optical disk 218.

The light reflected by the optical disk 218 passes through the objective lens 217, the hologram unit 216 and the rising prism 215 and is then reflected by the beam splitter 214, and is collected by the collimate lens 219 and is incident on the integrated optical member 222. The incident light is emitted from the first semiconductor laser device 211 and is separated from the light reflected by the optical disk 218, and furthermore, is divided into a light corresponding to an RF signal, a tracking error signal or a focus error signal and is incident on the first light receiving portion 223.

It is possible to employ a structure shown in FIG. 18 for the optical pick-up device 254 comprising the optical system for causing a light emitted from the first semiconductor laser device 211, the first light receiving portion 223 and the first semiconductor laser device 211 to be incident on the optical disk 218 and leading the light reflected by the optical disk 218 to the first light receiving portion 223. By such a structure, the optical pick-up device 254 comprises the first semiconductor laser device 211 having a high power, and furthermore, can have a thickness reduced.

### Eleventh Embodiment

An eleventh embodiment according to the invention will be described below with reference to the drawings. In the eleventh embodiment, explanation will be given to an optical disk device comprising the optical pick-up device 254 described in the tenth embodiment.

FIG. 19 is a perspective view showing an optical disk device according to the eleventh embodiment. In FIG. 19, a housing 251 is constituted by combining an upper housing 251a with a lower housing 251b. A tray 252 is provided to freely appear from the housing 251. The tray 252 is provided with a spindle motor 253 to be rotating and driving means for rotating an optical disk 218 and the optical pick-up device 254 described in the tenth embodiment. The optical pick-up device 254 includes a first semiconductor laser device 211 having a high power which includes the cap 201 for a semiconductor laser which has been described above, and serves to carry out at least one of an operation for writing information to the optical disk 218 and an operation for reading the information from the optical disk 218. For this reason, the optical pick-up device 254 has a high power, and furthermore, has a thickness reduced. Moreover, the tray 252 includes a feed driving system (not shown) to be moving means for causing the optical pick-up device 254 to approach the spindle motor 253 or separating the optical pick-up device 254 from the spindle motor 253. A bezel 255 is provided on a front end face of the tray 252 and is constituted to close the entrance of the tray 252 when the tray 252 is accommodated in the housing 251. A circuit board which is not shown is provided in the housing 251 and the tray 252, and an IC and a power circuit in a signal processing system are provided thereon. An external connector 256 is provided on a back side of the housing 251. The external connector 256 is connected to a power/signal line provided in electronic equipment such as a computer. A power is supplied into an optical disk device through the external connector 256 or an electric signal is led from an outside into the optical disk device or an electric signal generated in the optical disk device is sent to external electronic equipment.

In the optical disk device mounting the optical pick-up device 254 including the first semiconductor laser device 211 having the cap 201 for a semiconductor laser, as described above, the first semiconductor laser device 211 has a high power and the optical pick-up device 254 has a small thickness. Consequently, it is possible to obtain an optical disk device having a high power and a small thickness.

Although it is apparent that the semiconductor laser devices according to the fourth to ninth embodiments using the cap for a semiconductor laser according to the third embodiment can be applied to the optical pick-up device according to the first embodiment, it is also possible to further use each of the structures described in the first to eleventh embodiments in combination.

As described above, the optical pick-up device according to the invention and the optical disk device mounting the optical pick-up device according to the invention can maintain the recording and reproducing characteristics of information, and furthermore, can have a size reduced. Therefore, they can suitably be used for electronic equipment such as a personal computer, particularly, a notebook computer which is required to reduce a size.

This application is based upon and claims the benefit of priority of Japanese Patent Application No2004-331530 filed on 04/11/16 and Japanese Patent Application No2005-000389 filed on 05/01/05, the content of which is incorporated herein by references in its entirety.

What is claimed is:

1. An optical pick-up device for carrying out at least one of recording and reproduction of information for an optical disk, comprising:
a laser module, the laser module including:
a laser beam source, emitting a laser beam;
a laser beam source adjusting member, disposed on an opposite side of an emitting portion for emitting the laser beam of the laser beam source and having a first sliding surface setting a light emitting point of the laser beam source to be a center of rotation; and
a laser beam source shift member having a receiving surface for supporting the first sliding surface of the laser beam source adjusting member and having a second sliding surface which is almost perpendicular to an optical axis.

2. The optical pick-up device according to claim 1, wherein the laser beam source adjusting member is supported on the laser beam source shift member by a pressing member of the laser beam source shift member which is provided on an opposite side of the laser beam source adjusting member.

3. The optical pick-up device according to claim 2, wherein the pressing member is an elastic member.

4. The optical pick-up device according to claim 1, further comprising a plurality of laser beam sources, at least one of the laser beam sources constituting the laser module according to claim 1.

5. The optical disk device comprising the optical pick-up device according to claim 1, rotating and driving means for rotating an optical disk, and moving means for causing the optical pick-up device to approach the rotating and driving means and separating the optical pick-up device from the rotating and driving means.

6. The optical pick-up device according to claim 1, wherein the laser beam source includes:
a semiconductor laser unit;
a block provided with the semiconductor laser unit;
a stem provided with the block; and a cap for a semiconductor laser which is attached to the block; and
the cap for a semiconductor laser includes a cylindrical member having a side surface portion provided with a slit, the slit being provided to penetrate from an upper end of the side surface portion to a lower end thereof and having a width in a circumferential direction which is smaller than a width in a circumferential direction in the side surface portion projected in parallel with a surface of the slit.

7. The optical pick-up device according to claim 6, wherein the cylindrical member is constituted by an elastic member partially or wholly.

8. The optical pick-up device according to claim 6, wherein the cylindrical member is constituted by a bimetal partially or wholly and an inner peripheral side is formed of a metal having a greater coefficient of thermal expansion than that on an outer peripheral side.

9. The optical pick-up device according to claim 6, wherein the cylindrical member is constituted by a shape memory alloy partially or wholly.

10. The optical pick-up device according to claim 6, which is constituted to be vertically symmetrical or vertically rotation symmetrical.

11. The optical pick-up device according to claim 6, wherein a part of a lower end of the side surface portion is taken away.

12. The optical pick-up device according to claim 6, wherein the cap for a semiconductor laser is attached to the block by slightly increasing the width in the circumferential direction of the slit.

13. The optical pick-up device according to claim 6, wherein a part of a lower end of the side surface portion which is taken away is in the vicinity of the block.

14. The optical pick-up device according to claim 6, wherein a space surrounded by the side surface portion and the block is provided and the semiconductor laser unit is disposed in the space.

15. The optical pick-up device according to claim 14, wherein the space is provided by expanding the side surface portion side.

16. The optical pick-up device according to claim 14, wherein the space is provided by concaving the block.

17. An optical disk device, comprising:
an optical pick-up device, including a laser module having a laser beam source having a semiconductor laser unit;
a block, provided with the semiconductor laser unit;
a stem, provided with the block; and
a cap for a semiconductor laser, which is attached to the block, the cap for a semiconductor laser including a cylindrical member having a side surface portion provided with a slit, the slit being provided to penetrate from an upper end of the side surface portion to a lower end thereof and having a width in a circumferential direction which is smaller than a width in a circumferential direction of the side surface portion projected in parallel with a surface of the slit,
a laser beam source adjusting member, disposed on an opposite side of an emitting portion for emitting a laser beam of the laser beam source and having a first sliding surface setting a light emitting point of the laser beam source to be a center of rotation; and
a laser beam source shift member, having a receiving surface for supporting the first sliding surface of the laser beam source adjusting member and a second sliding surface which is almost perpendicular to an optical axis; and
rotating and moving means for rotating an optical disk, and moving means for causing the optical pick-up device to approach the rotating and driving means and separating the optical pick-up device from the rotating and driving means.
